(19) United States
(12) Patent Application Publication
(10) Pub. No.: US 2007/0172586 A1
(43) Pub. Date: Jul. 26, 2007

(54) Production method for color filter

(76) Inventors: Yuka Tachikawa, Tokyo (JP); Takayuki Tazaki, Tokyo (JP); Masafumi Kamada, Tokyo (JP); Tomoyuki Idehara, Tokyo (JP)

Correspondence Address: LADAS & PARRY LLP, 224 SOUTH MICHIGAN AVENUE, SUITE 1600, CHICAGO, IL, 60604, US

(21) Appl. No.: 11/656,278

(22) Filed: Jan. 22, 2007

(30) Foreign Application Priority Data
Jan. 23, 2006 (JP) 2006-014440
Sep. 29, 2006 (JP) 2006-270017

(51) Int. Cl. B05D 5/06; B05D 5/00; B05D 3/00

(52) U.S. Cl. 427/162; 427/256; 427/532

(57) ABSTRACT

A main object of the present invention is to provide a production method for a color filter capable of producing a color filter with little white spots by the ink jet method. To achieve the object, the present invention provides a production method for a color filter using a substrate for a color filter comprising a base material, and a light shielding part formed on the base material and having a plurality of opening parts, comprising: a lyophilic process step of processing each of a base material surface in the opening parts to be lyophilic by contacting each of the base material surface in the opening parts with lyophilic process solution containing a water soluble organic solvent having a hydroxyl group and water, and a colored layer forming step of forming a colored layer on each of the base material surface in the opening parts processed to be lyophilic in the lyophilic process step by an ink jet method.

### BACKGROUND OF THE INVENTION

1. Field of the Invention

The present invention relates to a production method for a color filter used for such as liquid crystal displays. More specifically, it relates to a production method for a color filter using an ink jet method.

2. Description of the Related Art

Recently, with the development of the personal computers, in particular, development of the portable personal computers, demand for the liquid crystal displays has been increased. Moreover, in these days, since the liquid crystal television sets for the domestic use have been more and more diffusing, the liquid crystal display market has been more and more expanding. Furthermore, the liquid-crystal displays diffused recently tend to be of a large screen size, and the tendency is remarkable in particular in the liquid crystal television sets for the domestic use.

Under such circumstances, it is required to produce the members comprising a liquid crystal display with a high quality and a high productivity at lower costs. In particular, since the color filters having the function of realizing the color display in the liquid crystal display have conventionally been of a high cost, such request is made frequently.

Such color filters, in general, comprise colored layers made of colored patterns of three primary colors of red (R), green (G) and blue (B) so that liquid crystals are operated as a back light shutter of the color filters by switching on or off the electrodes each corresponding to the pixels of R, G and B. Thereby, color liquid crystal display can be provided according to light transmission to the each pixel of R, G and B.

As a production method for such a color filter, conventionally, methods of repeating the same process three times for coloring the three colors of R, G, B such as a dye method and a pigment dispersion method have been used. However, even though the production methods are advantageous in that a color filter with highly precise R, G, B patterns can be formed, they are not always highly productive due to the need of repeating the same process for three times.

As a production method with this point improved, Japanese Patent Application Laid-Open (JP-A) No. 2000-187111 discloses a production method for a color filter using an ink jet method.

An example of such an ink jet method will be explained with reference to a drawing. FIG. 2 is a schematic diagram showing an example of the conventional ink jet method. As shown in FIG. 2, as the ink jet method, a method of forming a colored layer 30 in the opening part A by dropping colored layer forming coating solution 30′ from an ink jet head 40 into the opening part A using a substrate for a color filter 20 comprising a base material 21, and a light shielding part 22 having an opening part A formed on the base material 21 has been used.

Since the ink jet method is effective in terms of producing a large area color filter with a high productivity by successively moving the ink jet head, and thus it attracts the attention as a method capable of producing a color filter at low costs.

The ink jet method is for forming a colored layer utilizing the nature of minute liquid droplets of the colored layer forming coating solution, dropped onto the opening part of the above-mentioned light shielding part, to spread on the surface of the base material in the opening part after impacting thereon. Therefore, in the case the base material surface has a low lyophilic property with respect to the colored layer forming coating solution, a problem is involved in that the colored layer forming coating solution cannot be spread evenly in the opening part. If the colored layer forming coating solution cannot spread sufficiently, for example as shown in FIG. 3, a non-coated part B with no colored layer 30 formed is formed at the corner parts of the opening part of the light shielding part 22. If such a non-coated part B is formed, since a color cannot be developed only in the portion, it produces a “white spot” so as to deteriorate the display quality, and thus it is problematic.

With respect to the problems, JP-A No. 2002-122722 discloses a method for improving the lyophilic property of the base material surface of the opening part by contacting the base material surface in the opening part with water before the formation of the colored layer.

However, according to the method, the lyophilic property of the base material surface in the opening part cannot be always sufficient. Particularly at the time of producing a color filter for a large size liquid crystal television set having a pixel pattern with the opening part of a large area, or at the time of producing a color filter with a complicated pattern corner part of the opening part, it has been difficult to sufficiently restrain the generation of the above-mentioned “white spot”.

### SUMMARY OF THE INVENTION

The present invention has been achieved in view of the circumstances, and a main object thereof is to provide a production method for a color filter capable of producing a color filter with little white spots by the ink jet method.

To solve the above-mentioned problem, the present invention provides a production method for a color filter using a substrate for a color filter comprising a base material, and a light shielding part formed on the base material and having a plurality of opening parts, comprising: a lyophilic process step of processing each of a base material surface in the opening parts to be lyophilic by contacting each of the base material surface in the opening parts with lyophilic process solution containing a water soluble organic solvent having a hydroxyl group and water, and a colored layer forming step of forming a colored layer on the base material surface in the opening parts processed to be lyophilic in the lyophilic process step by an ink jet method.

According to the present invention, since the lyophilic process solution containing a water soluble organic solvent having a hydroxyl group and water is used as the lyophilic process solution to be used for having the “pixel surface” lyophilic by contacting with the base material surface in the opening part of the light shielding part (hereinafter, it may be referred to simply as the “pixel surface”) in the above-mentioned lyophilic process step, the lyophilic property of the pixel surface can be improved more remarkably than the case of using only water as the lyophilic process solution. Since the pixel surface can remarkably be processed to be lyophilic in the lyophilic process step, at the time of forming the colored layer in the above-mentioned colored layer forming step, remaining of a portion with no colored layer formed on the pixel surface can be prevented. Thereby, according to the production method for a colored filter of the present invention, a color filter with little white spots can be produced.

In the present invention, it is preferable that the above-mentioned water soluble organic solvent is alcohols. Since the alcohols are industrially accessible in variety, its kind can be selected optionally according to the degree of the lyophilic property to be provided to the pixel surf ace in the lyophilic process step.

In the present invention, the above-mentioned alcohols is preferably at least one selected from the group consisting of isopropyl alcohol, t-butanol, diacetone alcohol, propylene glycol monomethyl ether, 1,3-butane diol, and propylene glycol. Further, when the alcohols are used, the content of the alcohols in the lyophilic process solution is preferably in the range of 10% by mass to 50% by mass. Since the lyophilic property of the pixel surface can further be improved by using the lyophilic process solution in the lyophilic process step, a color filter with further little white spots can be produced.

In the invention, the base material is preferably made of an inorganic material; the light shielding part is made of a resin and a light shielding material; and a liquid repellent process step of processing the light shielding part to be liquid repellent by exposing plasma with a fluorine compound used as introduction gas to the light shielding part is provided before the lyophilic process step. According to the liquid repellent process step, a substrate for a color filter with the liquid repellent property of the light shielding part higher than the liquid repellent property of the base material can easily be formed. Moreover, in the present invention, since a substrate for a color filter with a high liquid repellent property of the light shielding part is used, generation of color mixture in the colored layer to be formed on the pixel surface can be prevented in the colored layer forming step.

In the invention, it is preferable to comprise a plasma pre-process step of exposing the plasma to the surface with the light shielding part formed of the substrate for a color filter before the lyophilic process step. Since the plasma pre-process step is provided, the organic material residue such as the light shielding material present on the pixel surface can be removed by dry etching before the lyophilic process step so that a color filter can be produced with little display defect accompanied by partial repellence in the opening part derived from the above-mentioned organic material residue.

Further, in the invention, it is preferable that the light shielding part contains a liquid repellent material having the liquid repellent property. Thereby, since a substrate for a color filter with the liquid repellent property of the light shielding part higher than the liquid repellent property of the base material surface can easily be formed, generation of color mixture in the colored layer to be formed on the pixel surface can be prevented in the colored layer forming step.

The production method for a color filter of the present invention can achieve the effect of producing a color filter with little white spots.

### BRIEF DESCRIPTION OF THE DRAWINGS

FIGS. 1A to 1C are each a schematic diagram showing an example of the production method for a color filter of the present invention;

FIG. 2 is a schematic diagram showing an example of the production method for a color filter using the conventional ink jet method; and

FIG. 3 is a schematic diagram showing an example of the color filter produced by the conventional ink jet method.

### DETAILED DESCRIPTION OF THE INVENTION

Hereinafter, the production method for a color filter according to the present invention will be explained in detail.

A production method for a color filter of the invention uses a substrate for a color filter comprising a base material, and a light shielding part formed on the base material and having a plurality of opening parts, comprising: a lyophilic process step of processing each of a base material surface in the opening parts to be lyophilic by contacting each of the base material surface in the opening parts with lyophilic process solution containing a water soluble organic solvent having a hydroxyl group and water, and a colored layer forming step of forming a colored layer on each of the base material surface in the opening parts processed to be lyophilic in the lyophilic process step by an ink jet method.

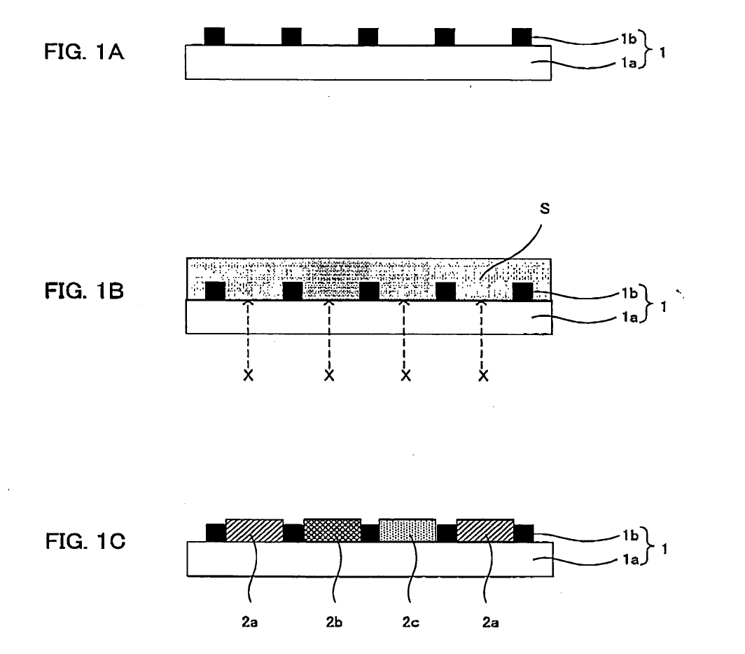

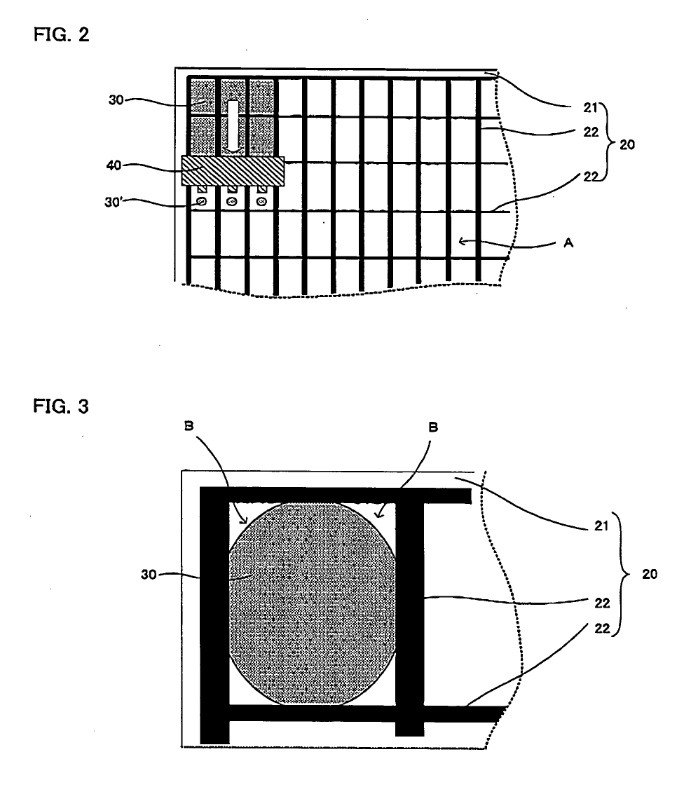

The production method for a color filter of the present invention will be explained with reference to the drawings. FIGS. 1A to 1C are each a schematic diagram showing an example of the production method for a color filter of the present invention. As shown in FIGS. 1A to 1C, the production method for a color filter of the present invention comprises at least; a lyophilic process step (FIG. 1B) of contacting a lyophilic process solution S with the surface X of the base material in the opening part of the light shielding part 1b, and a colored layer forming step (FIG. 1C) of forming colored layers 2a, 2b and 2c of plural colors by the ink jet method on the surface X of the base material processed to be lyophilic by the lyophilic process step; using a substrate for a color filter 1 (FIG. 1A) comprising a base material 1a, and a light shielding part 1b formed on the base material 1a and having an opening part, wherein the lyophilic process solution S contains a water soluble organic solvent having a hydroxyl group and water.

According to the present invention, since the lyophilic process solution containing a water soluble organic solvent having a hydroxyl group and water is used as the lyophilic process solution to be used for having the above-mentioned pixel surface lyophilic in the lyophilic process step, the lyophilic property of the pixel surface can be improved more remarkably than the case of using only water as the lyophilic process solution. Since the pixel surface can remarkably be processed to be lyophilic, at the time of forming the colored layer on the pixel surface by the ink jet method in the colored layer forming step, liquid droplets of the colored layer forming coating solution dropped and impacted on the pixel surface can easily be spread evenly to the corner parts in the opening part. Thus, remaining of a portion with no colored layer formed on the pixel surface can be prevented. Thereby, according to the production method for a colored filter of the present invention, a color filter with little white spots can be produced.

The ink jet method conventionally used for production of a color filter is for forming a colored layer as follows: dropping the colored layer forming coating solution in the opening part of the light shielding part of the substrate for a color filter by the ink jet method, and utilizing its nature of spreading after impacting in the opening part. Therefore, in the case the base material surface in the opening part has a low lyophilic property with respect to the above-mentioned colored layer forming coating solution, the colored layer forming coating solution cannot spread evenly in the opening part so that a portion with no colored layer formed remains in the opening part, in particular, at the corner parts so as to cause a problem of the “white spots” therefrom. For such a problem, a method of improving the lyophilic property of the base material surface in the opening part by contacting the base material surface in the opening part with water before forming the colored layer in the opening part of the light shielding part is known, however, according to the method, at the time of producing a color filter for a large size liquid crystal television set having a pixel pattern of a large area of the opening part or at the time of producing a color filter with a complicated pattern shape of the corner portion of the opening part, the lyophilic property of the base material surface in the opening part cannot be provided always sufficiently so that it has been difficult to sufficiently restrain generation of the “white spots”.

At this point, according to the present invention, since a solution containing water and a water soluble organic solvent having a hydroxyl group is used instead of using only water as the lyophilic process solution used for the above-mentioned lyophilic process step, the pixel surface can be processed to be more remarkably lyophilic compared with the case of using only water, and thereby a color filter with little white spots can be produced by the ink jet method.

In the production method for a color filter of the present invention, although the reason why the pixel surface can be more remarkably processed to be lyophilic by using water and a water soluble organic solvent having a hydroxyl group as the lyophilic process solution compared with the case of using only water is not clear, it is presumed to be based on the following mechanism. First, by adding an alcohol to water, the surface tension of the lyophilic process solution is lowered compared with water so as to improve the wetting property and the contacting property with respect to the base material to be processed. Second, the organic material dissolving property is improved by adding an alcohol so as to efficiently dissolve and eliminate the organic materials remaining in the opening part. Third, the water and alcohol molecules adsorb on the base material surface after eliminating the lyophilic process solution so as to form a surface with a higher affinity with the colored layer forming coating solution as an organic material to be added thereafter. However, since they are presumptions, and regardless of the above-mentioned mechanism, any one having the substantially same configuration as the technological idea mentioned in the claims and achieving the same effects can be incorporated in the technological scope of the present invention.

The above-mentioned “lyophilic” property in the present invention denotes the lyophilic property with respect to the colored layer forming coating solution to be dropped onto the above-mentioned pixel surface in the above-mentioned colored layer forming step.

The production method for a color filter of the present invention comprises at least the above-mentioned lyophilic process step and colored layer forming step, and as needed, it may comprise other steps. Hereafter, each step of the production method for a color filter of the present invention will be explained in detail.

### 1. Lyophilic Process Step

First, the lyophilic process step in the present invention will be explained. This is a step for processing the base material surface in the opening part lyophilic by contacting the lyophilic process solution containing a water soluble organic solvent having a hydroxyl group and water with the base material surface in the opening parts of the light shielding part, using a substrate for a color filter comprising a base material and a light shielding part formed on the base material and having a plurality of opening parts.

According to the present invention, since a solution containing a water soluble organic solvent having a hydroxyl group and water is used as the above-mentioned lyophilic process solution used in this step, the base material surface in the opening parts can remarkably be processed lyophilic, a color filter with little white spots can be produced.

Hereinafter, the lyophilic process step will be explained in detail.

### (1) Lyophilic Process Solution

The lyophilic process solution used in this step contains water, and a water soluble organic solvent having a hydroxyl group (hereafter, it may be referred to simply as a water soluble organic solvent).

The water soluble organic solvent used in this step has a water soluble property. Here, in the present invention, to have the “water soluble property” denotes to have the water soluble property of dissolving by 1% by mass or more with respect to 25° C. water.

The water soluble organic solvent used in this step is not particularly limited as long as it has the water soluble property, and it is particularly preferable to use one to be mixed freely with water in this step. Since a water soluble organic solvent to be mixed freely with water is used, the content ratio of the water soluble organic solvent in the above-mentioned lyophilic process solution can be changed optionally according to the degree of the lyophilic property to be provided to the pixel surface in this step.

The number of the hydroxyl group of the water soluble organic solvent is not particularly limited as long as it is in a range capable of providing the above-mentioned water soluble property according to such as the molecular weight of the water soluble organic solvent. The number of the hydroxyl group may be one or a plurality.

As an example of the water soluble organic solvent, alcohols, phenols, or carboxylic groups can be presented. In this step, any of the above-mentioned water soluble organic solvents can be used preferably, and it is particularly preferable to use the alcohols. Since the alcohols are industrially accessible in variety, its kind can be easily selected optionally according to the degree of the lyophilic property to be provided to the above-mentioned pixel surface in the lyophilic process step.

The alcohols used in this step are not particularly limited as long as they have a structure with a hydroxyl group bonded with a hydrocarbon chain. Moreover, the hydrocarbon chain may either be a straight chain or a branched chain. Moreover, the hydrocarbon chain may be bonded with a functional group as long as it is in a range capable of providing the above-mentioned water soluble property.

Such alcohols maybe any of an alcohol having a hydroxyl group in a molecule, a diol (glycol) having two hydroxyl groups in a molecule, a triol having three hydroxyl groups in a molecule, or a polyol having a plurality of more than three hydroxyl groups in a molecule. In particular, in this step, it is preferable to use the above-mentioned alcohol or the above-mentioned diol, and it is particularly preferable to use the alcohol.

Moreover, the above-mentioned alcohol may be a primary alcohol, or a secondary alcohol, or it may be a tertiary alcohol.

Furthermore, as the alcohol used in this step, it is preferable that the number of carbon atoms comprising a hydrocarbon chain with the hydroxyl group bonded is in the range of 1 to 6, more preferably in the range of 1 to 5, and particularly preferably in the range of 1 to 4. Since the number of carbon atoms comprising the hydrocarbon chain is in the above-mentioned range, it is easy to dry and eliminate the lyophilic process solution after contacting the same with the above-mentioned pixel surface in this step.

As such an alcohol, for example, methanol, ethanol, propanol, isopropyl alcohol, n-butanol, t-butanol, diacetone alcohol, propylene glycol monomethyl ether, 1,3-butane diol, or propylene glycol can be presented. In particular, in this step, it is preferable to use a secondary alcohol or a tertiary alcohol, and in particular, at least one selected from the group consisting of isopropyl alcohol, t-butanol, diacetone alcohol, propylene glycol monomethyl ether, 1,3-butane diol, and propyleneglycol can preferably be used.

Moreover, in the lyophilic process solution used in this step, the above-mentioned water soluble organic solvent may be contained by only one kind or by two or more kinds.

The content of the above-mentioned water soluble organic solvent in the lyophilic process solution used in this step maybe selected optionally according to the degree of the lyophilic property to be provided to the pixel surface in this step, the kind of the water soluble organic solvent, or the like. In particular, in this step, it is preferably in the range of 10% bymass to 50% bymass. Since thecontent of the water soluble organic solvent is in the above-mentioned range, the lyophilic property of the pixel surface can be further improved in this step. Here, the content of the water soluble organic solvent refers to the total content of the water soluble organic solvent in the lyophilic process solution used in this step. For example, in the case two or more kinds of the water soluble organic solvents are used for the lyophilic process solution, it denotes the content of the total (all of used) water soluble organic solvents.

Moreover, in the case of using at least one selected from the group consisting of isopropyl alcohol, t-butanol, diacetone alcohol, propylene glycol monomethyl ether, 1,3-butane diol, and propylene glycol as the above-mentioned water soluble organic solvent, the content of the water soluble organic solvent in the lyophilic process step is preferably in the range of 10% by mass to 50% by mass, and particularly preferably in the range of 15% by mass to 25% by mass. In the case of using only isopropyl alcohol, or only t-butanol as the water soluble organic solvent, since the content of the water soluble organic solvent is in the above-mentioned range, the lyophilic property of the pixel surface can further be improved in this step.

As the water used for the above-mentioned lyophilic process solution, pure water is used in general.

Moreover, the lyophilic process solution may contain a solvent other than the above-mentioned organic solvent having a hydroxyl group and water. As such a solvent, for example, acetone, ketones such as methyl ethyl ketone, cellosolve, or dioxane can be presented.

Furthermore, the lyophilic process solution may contain an additive such as a surfactant, a viscosity adjusting agent and a stabilizing agent.

### (2) Lyophilic Process Method

Next, the lyophilic process method of processing the above-mentioned pixel surface to be lyophilic using the above-mentioned lyophilic process solution in this step will be explained. The lyophilic process method used in this step is not particularly limited as long as it is a method capable of processing the pixel surface to be lyophilic by at least contacting the lyophilic process solution with the pixel surface. In general, a method comprising a solution contacting step of contacting the lyophilic process solution with the pixel surface, and a drying process of drying and eliminating the lyophilic process solution contacted with the pixel surface after the solution contacting step is used.

The method of contacting the lyophilic process solution with the pixel surface in the solution contacting step is not particularly limited as long as it is a method at least capable of contacting the lyophilic process solution with the pixel surface. As such a contacting method, for example, a method of contacting the lyophilic process solution with only the pixel surface, and a method of contacting the lyophilic process solution with the entire surface of the effective pixel range of the substrate for a color filter to be described later can be presented. In particular, the latter method is used preferably in this step from the viewpoint of the execution easiness.

As the method for contacting the lyophilic process solution with the entire surface of the effective pixel range of the substrate for a color filter, for example, a method of showering the lyophilic process solution; a method of spraying the lyophilic process solution; a method of dropping liquid droplets of the lyophilic process solution; a method of coating the lyophilic process solution by a coating method such as die coating, bead coating, spin coating and cap coating; a method of soaking the substrate for a color filter to be described later entirely in the lyophilic process solution; or a method of directing a ultrasonic wave to the substrate for a color filter in a state soaked in the lyophilic process solution can be presented. In this step, any of these methods can be used preferably, however, the method of showering the lyophilic process solution can be used preferably from the viewpoint of simplification of the production facility.

Moreover, the method for drying and eliminating the lyophilic process solution contacted with the pixel surface in the drying step is not particularly limited as long as it is a method capable of drying and eliminating the lyophilic process solution in a desired time. As such a method, for example, an air knife method of drying and eliminating by blowing compressed air; a spin method of drying and eliminating by rotating the substrate for a color filter; a hot plate method of drying and eliminating by contacting the substrate for a color filter with a hot plate; an oven method of drying and eliminating in a heated oven; or a reduced pressure drying method of drying in a reduced pressure can be presented. In this step, any of these methods can be used preferably, and it is particularly preferable to use the air knife method, the spin method, the reduced pressure drying method, or the like, capable of drying and eliminating without heating the above-mentioned pixel surface. Since it can be dried and eliminated without heating the pixel surface, even in the case the lyophilic process solution of the same composition is used, degree of processing the pixel surface to be lyophilic can further be improved in this step. In this step, among the drying and eliminating methods, the air knife method can be used more preferably from the viewpoint of the execution easiness.

### (3) Substrate for a Color Filter

Next, the substrate for a color filter used in this step will be explained. The substrate for a color filter used in this step comprises a base material, and a light shielding part formed on the base material and having a plurality of opening parts. Moreover, a colored layer is formed on the base material surface (pixel surface) in the above-mentioned opening parts in the colored layer forming step to be described later.

a. Light Shielding Part

First, the above-mentioned light shielding part will be explained. The light shielding part formed on the base material to be described later has a plurality of opening parts.

As the light shielding part used in this step, in general, one having opening parts of the same shape formed regularly by the equal interval is used. Here, the specific size and arrangement embodiment of the opening parts are not particularly limited, and they can be selected optionally according to such as the application of the color filter to be produced by the present invention.

Moreover, depending on the application of the color filter to be produced by the present invention, or the like, a light shielding part with opening parts having different shapes may be used. Also in this case, the specific size and arrangement embodiment of the opening parts are not particularly limited, and they can be selected optionally according to such as the application of the color filter to be produced by the present invention.

The light shielding part is not particularly limited as long as it is made of a material having a desired light shielding property. In general, one made of a light shielding material and a resin, or one made of a metal material can be used.

In the case of the light shielding part is made of a light shielding material and a resin, as the light shielding material, a material used in a resin light shielding part, generally used in a color filter, can be used Examples include light shielding particles such as carbon fine particles, a metal oxide, an inorganic pigment and an organic pigment.

Examples of the resin contained in the light shielding part include ethylene/vinyl acetate copolymer, ethylene/vinyl chloride copolymer, ethylene/vinyl copolymer, polystyrene, acrylonitrile/styrene copolymer, ABS resin, polymethacrylic acid resin, ethylene/methacrylic acid resin, polyvinyl chloride resin, chlorinated vinyl chloride, polyvinyl alcohol, cellulose acetate propionate, cellulose acetate butyrate, nylon 6, nylon 66, nylon 12, polyethylene terephthalate, polybutylene terephthalate, polycarbonate, polyvinyl acetal, polyether ether ketone, polyether sulfone, polyphenylene sulfide, polyarylate, polyvinyl butyral, epoxy resin, phenoxy resin, polyimide resin, polyamide imide resin, polyamic acid resin, polyether imide resin, phenol resin, and urea resin.

On the other hand, in the case the light shielding part is made of a metal material, the metal material is not particularly limited as long as it is a metal having a desired light shielding material, and in general a chromium material is used.

Moreover, the light shielding part may contain a liquid repellent material having a liquid repellent property. Since such a liquid repellent material is contained, a substrate for a color filter having a light shielding part with the excellent liquid repellent property can be obtained.

The liquid repellent material used in this step is not particularly limited as long as a desired liquid repellent property can be realized at the time of forming alight shielding part. As such a liquid repellent material, for example, a fluorine containing compound, or minute particles of a low surface energy substance can be presented.

As the fluorine containing compound, for example, a monomer, or an oligomer of the compounds represented by the following formulae (1) or (2) can be presented.

Rf-X-Rf′ General formula (1)

(Rf-X—R)—Y—(R′—X′—Rf′) General formula (2)

Here, in the formulae (1) or (2), Rf and Rf′ denote a fluoro alkyl group; R and R′ denote an alkylene group; and Rf and Rf′, or R and R′ may either be same or different. Moreover, X, X′ and Y denote any of —COO—, —OCOO—, —CONR″—, —OCONR″—, —SO₂NR″—, —SO₂—, —SO₂O—, —O—, —NR″—, —S—, —CO—, OSO₂O—, and —OPO(OH)O—; and X, X′ and Y may either be same or different. R″ denotes an alkyl group or a hydrogen.

Moreover, as the examples of the fluorine containing compound, polytetrafluoro ethylene, perfluoro ethylene propylene resin, or perfluoro alkoxy resin can also be used.

On the other hand, as the above-mentioned minute particles of a low surface energy substance, for example, minute particles of polyvinylidene fluoride, fluoro olefin vinyl ether based copolymer, or triethylene fluoride-vinylidene fluoride copolymer; or silicone minute particles can be presented.

The method of forming the light shielding part is not particularly limited as long as it is a method capable of forming the light shielding part with the above-mentioned opening parts disposed by a desired embodiment. As such a method, for example, a method of forming by a sputtering method using a metal such as chromium, a photolithography method using a resin composition containing light shielding particles, or a heat transfer method using the above-mentioned resin composition can be presented. Since the specific method for forming such a light shielding part is same as a method for forming a light shielding part used commonly for a color filter, the detailed explanation is omitted here.

b. Base Material

The base material used in the present invention is not particularly limited as long as the light shielding part and the colored layer can be formed, and those conventionally used for color filters can be used. Specifically, a transparent inorganic base material without flexibility, such as a quartz glass, a pyrex (registered trademark) glass, and a synthetic quartz plate, and a transparent resin base material having flexibility, such as a transparent resin film and an optical resin plate can be presented. In particular, it is preferable to use an inorganic base material in this step, and it is particularly preferable to use a glass base material among the inorganic materials. Furthermore, among the above-mentioned glass base materials, it is preferable to use a non alkaline type glass base material. Since the non alkaline type glass material has the excellent size stability and operability in a high temperature heating process, and it contains no alkaline component in the glass, it can be used preferably for a color filter for a color liquid crystal display of the active matrix system.

The base material may either be a transparent base material, a reflective base material, or one colored in white, however, a transparent one is used in general in this step.

Moreover, as needed, the base material may have a surface treatment for preventing alkaline elution, providing gas barrier property, or for other purposes. As such a surface treatment, for example, a process of exposing plasma, or the like with an oxygen gas provided as the introduction gas for processing the surface to be lyophilic can be presented.

c. Others

It is preferable that the substrate for a color filter used in this step has the liquid repellent property of the above-mentioned light shielding part higher than the liquid repellent property of the above-mentioned base material surface. Since a substrate for a color filter having a high liquid repellent property of the light shielding part is used in this step, spreading of the colored layer forming coating solution to be dropped into the opening parts of the light shielding part beyond the light shielding part to the other opening parts can be prevented in the colored layer forming step to be described later so that generation of color mixture in the colored layer of a color filter to be produced by the present invention can be prevented.

Here, the above-mentioned “liquid repellent property” denotes the liquid repellent property with respect to the colored layer forming coating solution to be dropped into the opening part of the light shielding part in the colored layer forming step to be described later.

The degree of the liquid repellent property of the light shielding part is not particularly limited as long as it has a liquid repellent property relatively higher than that of the base material surface. In particular, in this step, the liquid repellent property is preferably to the degree that the contact angle with respect to a liquid having a 40 mN/m surface tension is 10° or more; more preferably to the degree that the contact angle with respect to a liquid having a 30 mN/m surface tension is 100 or more; and further preferably to the degree that the contact angle with respect to a liquid having a 20 mN/m surface tension is 10° or more. Moreover, it is preferably to the degree that the contact angle with respect to pure water is 11° or more.

On the other hand, the lyophilic property of the base material surface is not particularly limited as long as it is higher than the lyophilic property of the light shielding part. In particular, in this step, the lyophilic property is preferably to the degree that the contact angle with respect to a liquid having a 40 mN/m surface tension is less than 9; more preferably to the degree that the contact angle with respect to a liquid having a 50 mN/m surface tension is 10° or less; and further preferably to the degree that the contact angle with respect to a liquid having a 60 mN/m surface tension is 100 or less.

As a method for producing a substrate for a color filter having the liquid repellent property of the liquid shielding part higher than that of the base material surface, for example, a method of forming the light shielding part by the above-mentioned method, using a material having a higher liquid repellent property than that of the base material surface as a material for the light shielding part, or a method of processing the liquid repellent property of the light shielding part to be higher than the liquid repellent property of the base material after forming the light shielding part on the base material by the above-mentioned method can be presented.

As the former method, a method of using one containing the above-mentioned liquid repellent material as the material for the light shielding part can be used preferably. According to the method, a substrate for a color filter with a light shielding part having a high liquid repellent property formed can be obtained without the need of additionally carrying out a step of processing the light shielding part to be liquid repellent.

On the other hand, as the latter method, a method of carrying out the plasma irradiation with a fluorine compound used as the introduction gas to the light shielding part after forming the light shielding part on the base material by the above-mentioned method, using a base material made of an inorganic material as the base material and one made of a resin and a light shielding material as the light shielding part can be used preferably. According to the method, since the fluorine can be introduced selectively only to the light shielding part containing a resin, a substrate for a color filter having a light shielding part with a liquid repellent property higher than that of the base material surface can easily be formed.

Here, since the method of carrying out the plasma irradiation in the presence of the fluorine containing compound to the light shielding part will be described in detail in the “3. Other steps” to be described later, the explanation is omitted here.

### 2. Colored Layer Forming Step

Next, the colored layer forming step in the present invention will be explained. This step is for forming a colored layer on the above-mentioned pixel surface processed to be lyophilic by the ink jet method in the lyophilic process step. In this step, since the pixel surface is processed to be lyophilic by the lyophilic process step, the colored layer can be formed evenly without a portion with no colored layer formed remaining on the above-mentioned pixel surface.

The method for forming a colored layer on the pixel surface in this step is not particularly limited as long as it is a method capable of forming a colored layer of a desired thickness on the each pixel surface. As such a method, in general, a method of dropping a colored layer forming coating solution using an ink jet head onto the pixel surface while moving the ink jet head or substrate for a color filter, is used.

The colored layer forming coating solution used in this step is not particularly limited as long as it can form a colored layer showing a desired color developing property, and one used commonly at the time of forming a colored layer for a color filter by the ink jet method can optionally be used. In particular, in this step, one containing a coloring agent, a curing component and an organic solvent can be used in general.

The coloring agent is not particularly limited as long as it can absorb a light beam of a desired wavelength. Such a coloring agent may either be a dye based material or a pigment based material. Since the coloring agent is same as the coloring agent commonly used for a color filter, the specific examples thereof are not explained here in detail.

The above-mentioned curing agent is for curing the coloring agent at the time of forming the colored layer in this step, and in general, a cross-linkable monomer, or the like is used. As such a curing component, for example, acrylic resin having a substituent such as a hydroxyl group, a carboxyl group, an alkoxy group, an epoxy group and an amide group; cellulose derivative of such as silicone resin, epoxy resin, hydroxy propyl cellulose, hydroxy ethyl cellulose, methyl cellulose, and carboxy methyl cellulose, or a modified product thereof; or vinyl based polymer such as polyvinyl pyrrolidone, polyvinyl alcohol and polyvinyl acetal can be presented.

Moreover, in this step, the curing components may be used by two or more kinds.

Moreover, the above-mentioned organic solvent is not particularly limited as long as it can dissolve the coloring agent and the curing component by a desired concentration. As such an organic solvent, for example, alkyl alcohols having 1 to 4 carbon atoms, such as methyl alcohol, ethyl alcohol, n-propyl alcohol, isopropyl alcohol, n-butyl alcohol, sec-butyl alcohol and tert-butyl alcohol; amides such as dimethyl formamide, and dimethyl acetamide; ketones or ketoalcohols such as acetone, and diacetone alcohol; ethers such as tetrahydrofuran and dioxane; polyalkylene glycols such as polyethylene glycol and polypropylene glycol; alkylene glycols with an alkylene group containing 2 to 4 carbons such as ethylene glycol, propylene glycol, butylene glycol, triethylene glycol, thiol glycol, hexylene glycol and diethylene glycol; glycerols; lower alkyl ethers of a polyhydric alcohol such as ethylene glycol monomethyl ether, diethylene glycol methyl ether, and triethylene glycol monomethyl ether; ethylene glycol monoalkyl ether acetates such as N-methyl-2-pyrrolidone, 2-pyrrolidone, and ethylene glycol monomethyl ether acetate; diethylene glycol monoalkyl ethers such as diethylene glycol monomethyl ether, and diethylene glycol monoethyl ether; diethylene glycol monoalkyl ether acetates such as diethylene glycol mono-n-butyl ether acetate; dipropylene glycol monoalkyl ether acetates such as dipropylene glycol monomethyl ether acetate; propylene glycol monoalkyl ether acetates such as propylene glycol monomethyl ether acetate and propylene glycol monoethyl ether acetate; other ethers such as diethylene glycol dimethyl ether; ketones such as cyclohexanone, 2-heptaone, and 3-heptanone; lactic acid alkyl esters such as 2-hydroxy ethyl propionate; other esters such as 3-methyl-3-ethoxy butyl propionate, 3-methoxy ethyl propionate, 3-ethoxy methyl propionate, 3-ethoxy ethyl propionate, n-butyl acetate, isobutyl acetate, n-amyl formate, isoamyl acetate, n-butyl propionate, ethyl butyrate, isopropyl butyrate, n-butyl butyrate and ethyl pyruvate; or γ-butyrolactone can be presented. In this step, in particular, diethylene glycol monobutyl ether acetate,a diethylene glycol monoethyl ether acetate, dipropylene glycol monomethyl ether acetate, 3-ethoxy ethyl propionate, dimethyl maronate, or the like can be used preferably.

Moreover, the above-mentioned organic solvents may be used as a mixture of two or more kinds, or furthermore, they may be used as a mixture with water.

The colored layer forming coating solution used in this step may contain a compound other than the above-mentioned coloring agent, curing agent and organic solvent. As the other compounds, for example, a surfactant, an anti foaming agent, an antiseptic, a cross-linking agent, or a photo polymerization initiating agent can be presented.

The specific composition of the above-mentioned colored layer forming coating solution can be adjusted optionally according to such as the specific method for forming a colored layer in this step, or the application of the color filter to be produced by the present invention.

The ink jet head used in this step is not particularly limited as long as it can drop the colored layer forming coating solution by a desired amount onto the base material surface in the opening part of the light shielding part. As such an ink jet head, for example, common ink jet heads such as those of an ejection system of controlling the ejection amount by a magnetic field while continuously ejecting a charged colored layer forming coating solution, those of an ejection system of intermittently ejecting a colored layer forming coating solution using a piezoelectric element, and those of an ejection system of intermittently ejecting a colored layer forming coating solution heated so as to utilize the foaming phenomenon thereof can be used.

### 3. Other steps

The production method for a color filter of the present invention may comprise a step other than the above-mentioned colored layer forming step. As such a step, the steps commonly used for the production of a color filter can be used. As the steps to be used particularly preferably in the present invention, a liquid repellent process step of processing the light shielding part of the above-mentioned substrate for a color filter to be liquid repellent before the above-mentioned lyophilic process step, and a plasma pre-process step of exposing the plasma to the surface with the light shielding part formed of the substrate for a color filter before the lyophilic process step can be presented.

### (1) Liquid Repellent Process Step

First, the liquid repellent process step will be explained. As mentioned above, this step is for improving the liquid repellent property of the light shielding part of the substrate for a color filter with respect to the colored layer forming coating solution before the lyophilic process step. Since the liquid repellent process step is provided, spreading of the colored layer forming coating solution to be dropped into the opening parts of the light shielding part to the other opening parts beyond the light shielding part can be prevented in the colored layer forming step so that generation of color mixture in the colored layer of a color filter to be produced by the present invention can be prevented; Thus it is preferable to have such a liquid repellent process step in the present invention.

The method for processing the light shielding part to be liquid repellent in the liquid repellent process step used in the present invention is not particularly limited as long as it is a method capable of making the liquid repellent property of the light shielding part relatively higher than the liquid repellent property of the base material surface used for the substrate for a color filter.

Here, the above-mentioned “liquid repellent property” denotes the liquid repellent property with respect to the colored layer forming coating solution.

The liquid repellent method is not particularly limited as long as it is a method capable of making for example the liquid repellent property of the light shielding part higher than the liquid repellent property of the base material surface in the opening part of the light shielding part. In particular, in the present invention, it is preferable to use a method of plasma irradiation to the light shielding part with a fluorine compound as the introduction gas while using a substrate for a color filter having a resin material as the material for the light shielding part and an inorganic material as the material for the base material. According to the method, since the fluorine compound can be introduced only into an organic material, the liquid repellent property of the light shielding part can easily be made higher than that of the base material as a result of the selective introduction of the fluorine only to the above-mentioned light shielding part.

Here, presence of the fluorine in the light shielding part at the time of carrying out the above-mentioned plasma irradiation can be confirmed by measuring the ratio of the fluorine element in the all elements detected from the light shielding part surface in the analysis with an X-ray photoelectron spectrometer (XPS: ESCALAB 220i-XL).

As the fluorine compound used for the above-mentioned introduction gas, for example, CF₄, SF₆, CHF₃, C₂F₆, C₃H₈, or C₅FB₈ can be presented.

Moreover, the introduction gas may be a mixture of the above-mentioned fluorine gas and another gas. As such another gas, for example, a nitrogen, an oxygen, an argon, or a helium can be presented, and it is particularly preferable to use a nitrogen. Furthermore, in the case of using a nitrogen as the above-mentioned other gas, the mixture ratio of the nitrogen is preferably 50% or more, and particularly preferably 60% or more.

Moreover, the above-mentioned method for exposing the plasma is not particularly limited as long as it is a method capable of processing the above-mentioned light shielding part to be liquid repellent. For example, the plasma irradiation can be carried out in a reduced pressure, or in an atmospheric pressure. In particular, in the present invention, it is particularly preferable to carry out the plasma irradiation in an atmospheric pressure because it is preferable in terms of such as the cost, or the production efficiency and because it does not the need the device of reducing the pressure or the like.

### (2) Plasma Pre-Process Step

Next, the above-mentioned plasma pre-process step will be explained. As mentioned above, this step is for exposing plasma to the surface with the above-mentioned light shielding part formed of the substrate for a color filter before the lyophilic process step. Since such a plasma pre-process step is provided, the residue present on the above-mentioned pixel surface can be eliminated by dry etching before the lyophilic process step so that a color filter with little display defect derived form the residue can be produced by the present invention.

Moreover, in the case of using the liquid repellent process step using the plasma irradiation method with the above-mentioned fluorine compound as the introduction gas, it is preferable to carry out this step before the above-mentioned liquid repellent process step for the following reason. That is, since the liquid repellent process step is for processing to be liquid repellent by the selective introduction of the fluorine to an organic material such as-a resin, if an organic material remains on the above-mentioned pixel surface, the portion is processed to be liquid repellent so that a coating defect may be generated in the above-mentioned colored layer forming step derived therefrom. However, since the organic material on the pixel surface can be eliminated before the liquid repellent process step by carrying out this step before the liquid repellent process step, generation of such a coating defect can be prevented.

The method for exposing the plasma to the surface with the light shielding part formed of the substrate for a color filter is not particularly limited as long as it is a-method capable of eliminating the residue present in the opening part of the light shielding part by dry etching, and a plasma irradiation method used commonly for eliminating an organic material by dry etching can be used. In particular, in this step, it is preferable to use a method of exposing plasma in the presence of an oxygen and at least one kind of the gases selected from the group consisting of nitrogen, helium and nitrogen.

### (3) Others

As a step to be used in the present invention other than liquid repellent process step and the above-mentioned plasma pre-process step, for example, an overcoat layer forming step of forming an overcoat layer on a colored layer to be formed by the above-mentioned colored layer forming step; a transparent electrode forming step of forming a transparent electrode of such as ITO or IZO on the above-mentioned colored layer; a spacer forming step of forming a spacer material for providing the cell gap with respect to a counter substrate evenly at a predetermined position; or an alignment control structure forming step of forming a structure for controlling the alignment of the liquid crystal can be presented.

The present invention is not limited to the above-mentioned embodiments. The above-mentioned embodiments are merely examples, and any one having the substantially same configuration as the technological idea disclosed in the claims of the present invention for achieving the same effects is incorporated in the technological scope of the present invention.

### EXAMPLES

Hereinafter, the present invention will be explained further specifically with reference to the examples.

### Example 1

### (1) Plasma Pre-Process Step

A light shielding substance containing mixture of the following composition was heated and dissolved at 90° C., separated by the centrifugal force at 12,000 rpm, and thereafter filtrated with a 1 μm glass filter. A light shielding part forming coating solution was prepared by adding 1% by mass of an ammonium bichromate as the cross-linking agent to the obtained water based coloring resin solution. Subsequently, by applying the above-mentioned light shielding part forming coating solution onto a base material comprising a glass substrate, exposing and developing so as to form a light shielding part, a substrate for a color filter was obtained.

<Composition of the light shielding substance containing
mixture>

| | | |
|---|---|---|
| Carbon black (#950 produced by Mitsubishi | 4.0 | parts by weight |
| Chemical Corporation) | | |
| Polyvinyl alcohol (GOHSENOL AH-26 produced | 0.7 | part by weight |
| by Nippon Synthetic Chemical Industry Co., Ltd.) | | |
| Ion exchange water | 95.3 | parts by weight |

Next, by exposing plasma to the surface with the above-mentioned light shielding part formed of the above-mentioned substrate for a color filter in a gas atmosphere of a mixture of an oxygen and a nitrogen by a 1:5 ratio, the residue in the opening part of the light shielding part was eliminated. At the time, the above-mentioned plasma irradiation conditions were as follows.

<Plasma irradiation conditions (plasma-pre-process step)>

| | |
|---|---|
| Power source output: | 150 V - 5 A |
| Electrode-substrate distance: | 2 mm |

### (2) Liquid Repellent Process Step

The light shielding part was processed to be liquid repellent by carrying out the plasma irradiation in a gas atmosphere with CF₄ and N₂ mixed by a 1:1 ratio to the surface with the light shielding part formed of the substrate for a color filter after eliminating the residue in the opening part of the light shielding part by the above-mentioned plasma pre-process step. The plasma irradiation conditions at the time were as follows. By the atmospheric pressure plasma irradiation, the light shielding part was processed to be a liquid repellent region, and the opening part with the above-mentioned glass substrate revealed was processed to be a lyophilic region. The contact angle with respect to pure water was measured using a contact angle measuring device (type CA-Z produced by Kyowa Interface Science Co., LTD.) each in the lyophilic region and the liquid repellent region. As a result, it was 7° in the lyophilic region, and it was 100° in the liquid repellent region.

<Plasma irradiation conditions (liquid repellent process
step)>

| | |
|---|---|
| Introduction gas: | CF₄, N₂ . . . 15 L/minute |
| Electrode-substrate distance: | 2 mm |
| Power source output: | 200 V - 5 A |

### (3) Lyophilic Process Step

The substrate for a color filter with the above-mentioned light shielding part processed to be liquid repellent by the above-mentioned liquid repellent process step was soaked in the lyophilic process solutions 1 to 8 of the compositions shown in the table 1 for 5 minutes, and then taken out from the lyophilic process solutions and dried by a spin method (5,000 rpm, 30 seconds).

TABLE 1

| | Isopropyl alcohol | Pure water |
|---|---|---|
| | (% by mass) | (% by mass) |
| Lyophilic process solution 1 | 1 | 99 |
| Lyophilic process solution 2 | 10 | 90 |
| Lyophilic process solution 3 | 14 | 86 |
| Lyophilic process solution 4 | 15 | 85 |
| Lyophilic process solution 5 | 16 | 84 |
| Lyophilic process solution 6 | 20 | 80 |
| Lyophilic process solution 7 | 25 | 75 |
| Lyophilic process solution 8 | 50 | 50 |

### (4) Colored Layer Forming Step

A colored layer was formed by coating a colored layer forming coating solution II having the following composition by the ink jet method on the base material surface in the above-mentioned opening part processed to be lyophilic by the lyophilic process step.

<Composition of the colored layer forming coating solution
I>

| | | |
|---|---|---|
| Pigment dispersion I: | 49.5 | parts by weight |
| Glycidyl methacrylate-methyl methacrylate | 10 | parts by weight |
| copolymer: | | |
| Polyfunctional epoxy compound (EPICOAT | 2 | parts by weight |
| 151S70): | | |
| Trimellitic acid: | 3.5 | parts by weight |
| Butyl carbitol acetate: | 35 | parts by weight |

(Composition of the pigment dispersion I)

| | | |
|---|---|---|
| C.I. Pigment Red 254: | 6.88 | parts by weight |
| C.I. Pigment Red 177: | 0.62 | part by weight |
| Byk 161: | 3 | parts by weight |
| N-phenyl maleinimide/benzyl methacrylate | 1 | part by weight |
| copolymer: | | |
| Butyl carbitol acetate: | 38 | parts by weight |

### Example 2

A color filter was produced by the same method as in the example 1 except that the lyophilic process solutions 9 to 16 having the composition shown in the table 2 were used as the lyophilic process solution used for the above-mentioned lyophilic process step.

TABLE 2

| | T-butanol | Pure water |
|---|---|---|
| | (% by mass) | (% by mass) |
| Lyophilic process solution 9 | 1 | 99 |
| Lyophilic process solution 10 | 10 | 90 |
| Lyophilic process solution 11 | 14 | 86 |
| Lyophilic process solution 12 | 15 | 85 |
| Lyophilic process solution 13 | 16 | 84 |
| Lyophilic process solution 14 | 20 | 80 |
| Lyophilic process solution 15 | 25 | 75 |
| Lyophilic process solution 16 | 50 | 50 |

### Example 3

A color filter was produced by the same method as in the example 1 except that the lyophilic process solutions 17 to 19 having the composition shown in the table 3 were used as the lyophilic process solution used for the above-mentioned lyophilic process step.

TABLE 3

| | Propylene glycol | Pure water |
|---|---|---|
| | (% by mass) | (% by mass) |
| Lyophilic process solution 17 | 10 | 90 |
| Lyophilic process solution 18 | 20 | 80 |
| Lyophilic process solution 19 | 50 | 50 |

### Comparative Example 1

A color filter was produced by the same method as in the example 1 except that pure water was used as the lyophilic process solution used for the above-mentioned lyophilic process step.

### Comparative Example 2

A color filter was produced by the same method as in the example 1 except that isopropyl alcohol was used alone as the lyophilic process solution used for the above-mentioned lyophilic process step.

### Comparative Example 3

A color filter was produced by the same method as in the example 1 except that t-butanol was used alone as the lyophilic process solution used for the above-mentioned lyophilic process step.

### Comparative Example 4

A color filter was produced by the same method as in the example 1 except that the above-mentioned lyophilic process was not executed.

### Evaluation

The color filters formed in the above-mentioned examples 1 to 3 and the comparative examples 1 to 4 were evaluated as follows.

### (1) Lyophilic Property Evaluation

The degree of the lyophilic process of the base material surface in the opening part after the above-mentioned lyophilic process step in the above-mentioned examples and comparative examples was evaluated. Evaluation was carried out by dropping 10 pL (pico litters) of the colored layer forming coating solution II of the above-mentioned composition onto the base material surface in the opening part by the ink jet method, and measuring the diameter (impact diameter) of the round colored layer formed on the base material surface. According to the evaluation method, in the case the above-mentioned lyophilic degree is high, the dropped colored layer forming coating solution can easily spread so that the above-mentioned impact diameter becomes larger, and on the other hand, in the case the lyophilic degree is low, the impact diameter becomes smaller.

The above-mentioned impact diameter was found out by taking in the image of the above-mentioned colored layer with an optical microscope and actually measuring the impact diameter with an image analysis soft ware (Image-Pro plus: produced by Nippon Roper K. K). Here, in the case the above-mentioned colored layer is elliptical, the length of the longer axis was regarded as the impact diameter.

### (2) White Spot Evaluation

The white spots of the color filters produced in the above-mentioned examples and comparative examples were evaluated. Evaluation was carried out by enlarging and displaying the pixels with an optical microscope for judging presence or absence of a portion with a low color density so as to be observed whitely and specifying the position thereof in a pixel. The criteria of the white spot evaluation were as follows.
⊚: No white spot
◯: Scarce white spots
Δ: Little white spots
X: Many white spots

### (3) Evaluation results

The results of the above-mentioned lyophilic property evaluation and white spot evaluation are shown in the following table 4. As shown in the table 4, the lyophilic property of the base material surface in the opening part was more improved in the above-mentioned lyophilic process step in the examples than the comparative examples using only water or a solvent as the above-mentioned lyophilic process solution. Moreover, the white spots were found less in the above-mentioned examples than in the above-mentioned comparative examples.

TABLE 4

| | | Impact diameter | | |
|---|---|---|---|---|
| | | (μm) | | White |
| | | Base | Light | spot |
| | | material | shielding | eval- |
| | | surface | part | uation |
| Example 1 | Lyophilic process solution 1 | 143 | 45 | Δ |
| | Lyophilic process solution 2 | 151 | 45 | ◯ |
| | Lyophilic process solution 3 | 174 | 47 | ◯ |
| | Lyophilic process solution 4 | 206 | 47 | ⊚ |
| | Lyophilic process solution 5 | 220 | 49 | ⊚ |
| | Lyophilic process solution 6 | 192 | 45 | ⊚ |
| | Lyophilic process solution 7 | 191 | 48 | ⊚ |
| | Lyophilic process solution 8 | 180 | 48 | ◯ |
| Example 2 | Lyophilic process solution 9 | 140 | 47 | Δ |
| | Lyophilic process solution 10 | 170 | 45 | ◯ |
| | Lyophilic process solution 11 | 181 | 47 | ◯ |
| | Lyophilc process solution 12 | 204 | 45 | ⊚ |
| | Lyophilic process solution 13 | 209 | 46 | ⊚ |
| | Lyophilic process solution 14 | 199 | 48 | ⊚ |
| | Lyophilic process solution 15 | 191 | 45 | ⊚ |
| | Lyophilic process solution 16 | 175 | 46 | ◯ |
| Example 3 | Lyophilic process solution 17 | 152 | 44 | ◯ |
| | Lyophilic process solution 18 | 139 | 43 | Δ |
| | Lyophilic process solution 19 | 146 | 43 | Δ |

| | | | |
|---|---|---|---|
| Comparative example 1 | 121 | 46 | X |
| Comparative example 2 | 141 | 66 | Δ |
| Comparative example 3 | 137 | 58 | Δ |
| Comparative example 4 | 100 | 45 | X |

### Example 4

### (1) Plasma Pre-Process Step

A light shielding substance containing mixture of the following composition was heated and dissolved at 90° C., separated by the centrifugal force at 12,000 rpm, and thereafter filtrated with a 1 μm glass filter. A light shielding part forming coating solution was prepared by adding 1% by mass of ammonium bichromate as the cross-linking agent to the obtained water based coloring resin solution. Subsequently, by applying the light shielding part forming coating solution onto a base material comprising a glass substrate, exposing and developing so as to form a light shielding part, a substrate for a color filter was obtained.

<Composition of the light shielding substance containing mixture>

| | | |
|---|---|---|
| Carbon black (#950 produced by Mitsubishi | 4.0 | parts by weight |
| Chemical Corporation.) | | |
| Polyvinyl alcohol (GOHSENOL AH-26 produced | 0.7 | part by weight |
| by Nippon Synthetic Chemical Industry Co., Ltd.) | | |
| Ion exchange water | 95.3 | parts by weight |

Next, by exposing plasma to the surface with the above-mentioned light shielding part formed of the above-mentioned substrate for a color filter in a gas atmosphere of a mixture of an oxygen and a nitrogen by a 1:5 ratio, the residue in the opening part of the light shielding part was eliminated. At the time, the plasma irradiation conditions were as follows.

<Plasma irradiation conditions (plasma pre-process step)>

| | |
|---|---|
| Power source output: | 150 V - 5 A |
| Electrode-substrate distance: | 2 mm |

### (2) Liquid Repellent Process Step

The above-mentioned light shielding part was processed to be liquid repellent by carrying out the plasma irradiation in a gas atmosphere with CF₄ and N₂ mixed by a 1:1 ratio to the surface with the above-mentioned light shielding part formed of the substrate for a color filter after eliminating the residue in the opening part of the light shielding part by the above-mentioned plasma pre-process step. The plasma irradiation conditions at the time were as follows. By the atmospheric pressure plasma irradiation, the light shielding part was processed to be a liquid repellent region, and the opening part with the above-mentioned glass substrate revealed was processed to be a lyophilic region. The contact angle with respect to pure water was measured using a contact angle measuring device (type CA-Z produced by Kyowa Interface Science Co., LTD.) each in the lyophilic region and the liquid repellent region. As a result, it was 7° in the lyophilic region, and it was 100° in the liquid repellent region.

<Plasma irradiation conditions (liquid repellent process step)>

| | |
|---|---|
| Introduction gas: | CF₄, N₂ . . . 15 L/minute |
| Electrode-substrate distance: | 2 mm |
| Power source output: | 200 V - 5 A |

### (3) Lyophilic Process Step

The substrate for a color filter with the above-mentioned light shielding part processed to be liquid repellent by the above-mentioned liquid repellent process step was soaked in the lyophilic process solutions 20 to 24 of the compositions shown in the table 5 for 5 minutes each, and then taken out from the lyophilic process solutions and dried by a spin method (5,000 rpm, 30 seconds).

TABLE 5

| | Isopropyl | |
|---|---|---|
| | alcohol | Pure water |
| | (% by mass) | (% by mass) |
| Lyophilic process solution 20 | 10 | 90 |
| Lyophilic process solution 21 | 15 | 85 |
| Lyophilic process solution 22 | 20 | 80 |
| Lyophilic process solution 23 | 25 | 75 |
| Lyophilic process solution 24 | 30 | 70 |

### (4) Colored Layer Forming Step

A colored layer was formed by coating a colored layer forming coating solution II having the following composition by the ink jet method on the base material surface in the above-mentioned opening part processed to be lyophilic by the above-mentioned lyophilic process step.

<Composition of the colored layer forming coating solution II>

| | | |
|---|---|---|
| Pigment dispersion II: | 33 | parts by weight |
| Glycidyl methacrylate-methyl methacrylate | 15 | parts by weight |
| copolymer: | | |
| Polyfunctional epoxy compound | 3 | parts by weight |
| (EPICOAT 151S70): | | |
| Trimellitic acid: | 4.5 | parts by weight |
| Butyl carbitol acetate: | 44.5 | parts by weight |

(Composition of the pigment dispersion II)

| | | |
|---|---|---|
| C.I. Pigment Blue 15:6: | 4.68 | parts by weight |
| C.I. Pigment Blue 23: | 0.32 | part by weight |
| Byk 161: | 1.5 | parts by weight |
| N-phenyl maleinimide/benzyl methacrylate | 1.5 | parts by weight |
| copolymer: | | |
| Butyl carbitol acetate: | 25 | parts by weight |

### Example 5

A color filter was produced by the same method as in the example 4 except that the lyophilic process solutions 25 to 29 having the composition shown in the table 6 were used as the lyophilic process solution used for the above-mentioned lyophilic process step.

TABLE 6

| | t-butanol | Pure water |
|---|---|---|
| | (% by mass) | (% by mass) |
| Lyophilic process solution 25 | 10 | 90 |
| Lyophilic process solution 26 | 15 | 85 |
| Lyophilic process solution 27 | 20 | 80 |
| Lyophilic process solution 28 | 25 | 75 |
| Lyophilic process solution 29 | 30 | 70 |

### Example 6

A color filter was produced by the same method as in the example 4 except that the lyophilic process solutions 30 to 34 having the composition shown in the table 7 were used as the lyophilic process solution used for the above-mentioned lyophilic process step.

TABLE 7

| | Diacetone | |
|---|---|---|
| | alcohol | Pure water |
| | (% by mass) | (% by mass) |
| Lyophilic process solution 30 | 10 | 90 |
| Lyophilic process solution 31 | 15 | 85 |
| Lyophilic process solution 32 | 20 | 80 |
| Lyophilic process solution 33 | 25 | 75 |
| Lyophilic process solution 34 | 30 | 70 |

### Example 7

A color filter was produced by the same method as in the example 4 except that the lyophilic process solutions 35 to 39 having the composition shown in the table 8 were d as the lyophilic process solution used for the above-mentioned lyophilic process step.

TABLE 8

| | Propylene glycol | |
|---|---|---|
| | monomethyl ether | Pure water |
| | (% by mass) | (% by mass) |
| Lyophilic process solution 35 | 10 | 90 |
| Lyophilic process solution 36 | 15 | 85 |
| Lyophilic proeess solution 37 | 20 | 80 |
| Lyophilic process solution 38 | 25 | 75 |
| Lyophilic process solution 39 | 30 | 70 |

### Example 8

A color filter was produced by the same method as in the example 4 except that the lyophilic process solutions 40 to 44 having the composition shown in the table 9 were used as the lyophilic process solution used for the above-mentioned lyophilic process step.

TABLE 9

| | 1,3-butane diol | Pure water |
|---|---|---|
| | (% by mass) | (% by mass) |
| Lyophilic process solution 40 | 10 | 90 |
| Lyophilic process solution 41 | 15 | 85 |
| Lyophilic process solution 42 | 20 | 80 |
| Lyophilic process solution 43 | 25 | 75 |
| Lyophilic prooess solution 44 | 30 | 70 |

### Example 9

A color filter was produced by the same method as in the example 4 except that the lyophilic process solutions 45 to 49 having the composition shown in the table 10 were used as the lyophilic process solution used for the above-mentioned lyophilic process step.

TABLE 10

| | Propylene glycol | Pure water |
|---|---|---|
| | (% by mass) | (% by mass) |
| Lyophilic process | 10 | 90 |
| solution 45 | | |
| Lyophilic process | 15 | 85 |
| solution 46 | | |
| Lyophilic process | 20 | 80 |
| solution 47 | | |
| Lyophilic process | 25 | 75 |
| solution 48 | | |
| Lyophilic process | 30 | 70 |
| solution 49 | | |

### Comparative Example 5

A color filter was produced by the same method as in the example 4 except that isopropyl alcohol was used alone as the lyophilic process solution used for the above-mentioned lyophilic process step.

### Comparative Example 6

A color filter was produced by the same method as in the example 4 except that t-butanol was used alone as the lyophilic process solution used for the above-mentioned lyophilic process step.

### Comparative Example 7

A color filter was produced by the same method as in the example 4 except that diacetone alcohol was used alone as the lyophilic process solution used for the above-mentioned lyophilic process step.

### Comparative Example 8

A color filter was produced by the same method as in the example 4 except that propylene glycol monomethyl ether was used alone as the lyophilic process solution used for the above-mentioned lyophilic process step.

### Comparative Example 9

A color filter was produced by the same method as in the example 4 except that 1,3-butane diol was used alone as the lyophilic process solution used for the above-mentioned lyophilic process step

### Comparative Example 10

A color filter was produced by the same method as in the example 4 except that propylene glycol was used alone as the lyophilic process solution used for the above-mentioned lyophilic process step

### Comparative Example 11

A color filter was produced by the same method as in the example 4 except that pure water was used alone as the lyophilic process solution used for the above-mentioned lyophilic process step.

### Comparative Example 12

A color filter was produced by the same method as in the example 1 except that the above-mentioned lyophilic process was not executed.

### (Evaluation)

The color filters formed in the above-mentioned examples 4 to 9 and the comparative Examples 5 to 12 were evaluated as follows.

### (1) Lyophilic Property Evaluation

The degree of the lyophilic process of the base material surface in the above-mentioned opening part after the lyophilic process step in the above-mentioned examples and comparative Examples was evaluated. Evaluation was carried out by dropping 10 pL (pico litters) of the colored layer forming coating solution II of the above-mentioned composition onto the base material surface in the above-mentioned opening part by the ink jet method, and measuring the diameter (impact diameter) of the round colored layer formed on the above-mentioned base material surface. According to the evaluation method, in the case the above-mentioned lyophilic degree is high, the dropped colored layer forming coating solution can easily spread so that the above-mentioned impact diameter becomes larger, and on the other hand, in the case the lyophilic degree is low, the impact diameter becomes smaller.

The impact diameter was found out by taking in the image of the above-mentioned colored layer with an optical microscope and actually measuring the impact diameter with an image analysis soft ware (Image-Pro plus: produced by Nippon Roper K. K.) Here, in the case the colored layer is elliptical, the length of the longer axis was regarded as the impact diameter.

### (2) White Spot Evaluation

The white spots of the color filters produced in the above-mentioned examples and comparative Examples were evaluated. Evaluation was carried out by enlarging and displaying the pixels with an optical microscope for judging presence or absence of a portion with a low color density so as to be observed whitely and specifying the position thereof in a pixel. The criteria of the white spot evaluation were as follows.
⊚: No white spot
◯: Scarce white spots
Δ: Little white spots
X: Many white spots

### (3) Evaluation Results

The results of the above-mentioned lyophilic property evaluation and the white spot evaluation are shown in the following table 11. As shown in the table 11, the lyophilic property of the base material surface in the above-mentioned opening part was more improved in the above-mentioned lyophilic process step in the examples than the comparative Examples using only water or a solvent as the above-mentioned lyophilic process solution. Moreover, the white spots were found less in the examples than in the comparative Examples.

TABLE 11

| | | Impact diameter | | |
|---|---|---|---|---|
| | | (μm) | | White |
| | | Base | Light | spot |
| | | material | shielding | eval- |
| | | surface | part | uation |
| Example 4 | Lyophilic process solution 20 | 165 | 45 | ◯ |
| | Lyophilic process solution 21 | 206 | 44 | ⊚ |
| | Lyophilic process solution 22 | 205 | 46 | ⊚ |
| | Lyophilic process solution 23 | 198 | 47 | ⊚ |
| | Lyophilic process solution 24 | 185 | 48 | ◯ |
| Example 5 | Lyophilic process solution 25 | 159 | 45 | ◯ |
| | Lyophilic process solution 26 | 195 | 48 | ⊚ |
| | Lyophilic process solution 27 | 192 | 47 | ⊚ |
| | Lyophilic process solution 28 | 189 | 47 | ⊚ |
| | Lyophilic process solution 29 | 178 | 48 | ◯ |
| Example 6 | Lyophilic process solution 30 | 146 | 46 | Δ |
| | Lyophilic process solution 31 | 153 | 44 | ◯ |
| | Lyophilic process solution 32 | 160 | 43 | ◯ |
| | Lyophilic process solution 33 | 159 | 47 | ◯ |
| | Lyophilic process solution 34 | 148 | 47 | Δ |
| Example 7 | Lyophilic process solution 35 | 149 | 47 | Δ |
| | Lyophilic process solution 36 | 175 | 48 | ◯ |
| | Lyophilic process solution 37 | 179 | 49 | ◯ |
| | Lyophilic process solution 38 | 168 | 47 | ◯ |
| | Lyophilic process solution 39 | 155 | 48 | ◯ |
| Example 8 | Lyophilic process solution 40 | 143 | 45 | Δ |
| | Lyophilic process solution 41 | 158 | 47 | ◯ |
| | Lyophilic process solution 42 | 162 | 44 | ◯ |
| | Lyophilic process solution 43 | 150 | 45 | ◯ |
| | Lyophilic process solution 44 | 142 | 48 | Δ |
| Example 9 | Lyophilic process solution 45 | 145 | 46 | Δ |
| | Lyophilic process solution 46 | 163 | 48 | ◯ |
| | Lyophilic process solution 47 | 170 | 48 | ◯ |
| | Lyophilic process solution 48 | 160 | 45 | ◯ |
| | Lyophilic process solution 49 | 156 | 47 | ◯ |

| | | | |
|---|---|---|---|
| Comparative example 5 | 146 | 64 | Δ |
| Comparative example 6 | 140 | 58 | Δ |
| Comparative example 7 | 133 | 56 | Δ |
| Comparative example 8 | 137 | 56 | Δ |
| Comparative example 9 | 138 | 67 | Δ |
| Comparative example 10 | 130 | 62 | Δ |
| Comparative example 11 | 123 | 45 | X |
| Comparative example 12 | 105 | 46 | X |

What is claimed is:

1. A production method for a color filter using a substrate for a color filter comprising a base material, and a light shielding part formed on the base material and having a plurality of opening parts, comprising:
a lyophilic process step of processing each of a base material surface in the opening parts to be lyophilic by contacting each of the base material surface in the opening parts with lyophilic process solution containing a water soluble organic solvent having a hydroxyl group and water, and
a colored layer forming step of forming a colored layer on each of the base material surface in the opening parts processed to be lyophilic in the lyophilic process step by an ink jet method.

2. The production method for a color filter according to claim 1, wherein the water soluble organic solvent is alcohols.

3. The production method for a color filter according to claim 2, wherein the alcohols is at least one selected from the group consisting of isopropyl alcohol, t-butanol, diacetone alcohol, propylene glycol monomethyl ether, 1,3-butane diol, and propylene glycol.

4. The production method for a color filter according to claim 3, wherein a content of the alcohols in the lyophilic process solution is in the range of 10% by mass to 50% by mass.

5. The production method for a color filter according to claim 1, wherein the base material is made of an inorganic material; the light shielding part is made of a resin and a light shielding material; and a liquid repellent process step of processing the light shielding part to be liquid repellent by exposing plasma with a fluorine compound used as introduction gas to the light shielding part is provided before the lyophilic process step.

6. The production method for a color filter according to claim 2, wherein the base material is made of an inorganic material; the light shielding part is made of a resin and a light shielding material; and a liquid repellent process step of processing the light shielding part to be liquid repellent by exposing plasma with a fluorine compound used as introduction gas to the light shielding part is provided before the lyophilic process step.

7. The production method for a color filter according to claim 3, wherein the base material is made of an inorganic material; the light shielding part is made of a resin and a light shielding material; and a liquid repellent process step of processing the light shielding part to be liquid repellent by exposing plasma with a fluorine compound used as introduction gas to the light shielding part is provided before the lyophilic process step.

8. The production method for a color filter according to claim 4, wherein the base material is made of an inorganic material; the light shielding part is made of a resin and a light shielding material; and a liquid repellent process step of processing the light shielding part to be liquid repellent by exposing plasma with a fluorine compound used as introduction gas to the light shielding part is provided before the lyophilic process step.

9. The production method for a color filter according to claim 1, comprising a plasma pre-process step of exposing plasma to a surface with the light shielding part formed of the substrate for a color filter before the lyophilic process step.

10. The production method fora color filter according to claim 2, comprising a plasma pre-process step of exposing plasma to a surface with the light shielding part formed of the substrate for a color filter before the lyophilic process step.

11. The production method fora color filter according to claim 3, comprising a plasma pre-process step of exposing plasma to a surface with the light shielding part formed of the substrate for a color filter before the lyophilic process step.

12. The production method for a color filter according to claim 4, comprising a plasma pre-process step of exposing plasma to a surface with the light shielding part formed of the substrate for a color filter before the lyophilic process step.

13. The production method for a color filter according to claim 5, comprising a plasma pre-process step of exposing plasma to a surface with the light shielding part formed of the substrate for a color filter before the lyophilic process step.

14. The production method for a color filter according to claim 6, comprising a plasma pre-process step of exposing plasma to a surface with the light shielding part formed of the substrate for a color filter before the lyophilic process step.

15. The production method for a color filter according to claim 7, comprising a plasma pre-process step of exposing plasma to a surface with the light shielding part formed of the substrate for a color filter before the lyophilic process step.

16. The production method for a color filter according to claim 8, comprising a plasma pre-process step of exposing plasma to a surface with the light shielding part formed of the substrate for a color filter before the lyophilic process step.

17. The production method for a color filter according to claim 1, wherein the light shielding part contains a liquid repellent material having a liquid repellent property.

18. The production method fora color filter according to claim 2, wherein the light shielding part contains a liquid repellent material having a liquid repellent property.

19. The production method fora color filter according to claim 3, wherein the light shielding part contains a liquid repellent material having a liquid repellent property.

20. The production method for a color filter according to claim 4, wherein the light shielding part contains a liquid repellent material having a liquid repellent property.
